(19) United States
(12) Patent Application Publication
(10) Pub. No.: US 2015/0249327 A1
(43) Pub. Date: Sep. 3, 2015

(54) ELECTRICAL OUTLET COVER

(71) Applicant: Amy Michelle Nedrich, Canonsburg, PA (US)

(72) Inventor: Amy Michelle Nedrich, Canonsburg, PA (US)

(21) Appl. No.: 14/339,927

(22) Filed: Jul. 24, 2014

Related U.S. Application Data
(63) Continuation-in-part of application No. 13/629,576, filed on Sep. 27, 2012, now abandoned.
(60) Provisional application No. 61/556,607, filed on Nov. 7, 2011.

(51) Int. Cl. H02G 3/14

(52) U.S. Cl. CPC H02G 3/14

(57) ABSTRACT

An electrical outlet cover that is safe, accessible/removable, aesthetically pleasing, and adaptable and configurable in design is provided. The electrical outlet cover can be used to cover outlets in older homes that may not be up to today's electrical codes, thus improving the safety of the home. The electrical outlet cover can also prevent children or pets from accessing any part of the wall outlet. The electrical outlet cover may form at least one row of perforation so as to be easily adapted to allow a user to manually tear, snap, break, or otherwise rend the configurable electrical outlet cover into at least two separate pieces without the need for a separate tool, such as a scissors or the like. As a result, the electrical outlet cover can cover an entire electrical outlet wall plate, or can be designed to cover an unused portion of the wall plate.

### CROSS-REFERENCE TO RELATED APPLICATION

This application is a continuation-in-part application of U.S. non-provisional application Ser. No. 13/629,576, filed Sep. 27, 2012, and claiming the benefit priority of U.S. provisional application No. 61/556,607, filed Nov. 7, 2011, the contents of each and every application are herein incorporated by reference.

### BACKGROUND OF THE INVENTION

The present invention relates to electrical outlet covers and more particularly, to a removable wall plate that completely covers that can be easily configured to partially cover electrical outlets and their wall plates when the need arises.

Electrical outlets are typically placed throughout a home or business for ready access to electrical power, and the electrical outlets are usually covered with a conventional wall plate. Many times, these electrical outlets are positioned where children can easily reach them. A child may insert an electrically conductive object or a finger into such an electrical outlet, resulting in an electric shock.

There are many items on the market today that help “child-proof” electrical outlets. While often achieving the desired purpose, these items can be difficult to remove if access to the outlet is needed because they are not adaptable or configurable so as to fit partially employed electrical outlets or in obstructed areas. Moreover, such items may not fit all designs of outlets, especially older ones.

In older homes, there may be one or more electrical outlets that are not up to code or unsafe to use. There is currently nothing available for the user that wishes to cover such an outlet in an aesthetically pleasing manner.

As can be seen, there is a need for an electrical outlet cover that is removable and easily configurable to various situations, such as when one of a double socket electrical outlet is currently being employed or when there is an obstruction to coverage.

### SUMMARY OF THE INVENTION PATENT

In one aspect of the present invention, a configurable electrical outlet covering device comprises: a cover; a set of prongs extending from a rear side of the cover, the set of prongs operable to fit into an electrical outlet; rounded edges disposed about an outer periphery of the cover; and a row of perforation formed in the cover and extending from a first side to a second side and adapted to allow a user to manually rend the cover into a portion cover and a remaining portion cover.

In another aspect of the present invention, a method of child-proofing a plurality of double electrical outlet sockets using a single type of configurable electrical outlet cover in order to lower costs, comprises: providing a plurality of configurable electrical outlet covers, wherein each configurable electrical outlet cover comprises: a cover; two sets of prongs extending from a rear side of the cover, wherein the two sets of prongs are disposed to operably engage double socket electrical outlets; and a row of perforation formed in the cover and extending from a first side to a second side and adapted to allow a user to manually rend the cover into a portion cover and a remaining portion cover, each portion cover and remaining portion cover having one set of prongs; engaging both sockets respectively with the two sets of prongs of one cover, when both electrical outlet sockets of the double socket electrical outlet are unemployed; manually rending another configurable electrical outlet cover along the row of perforation, when confronted with a double socket electrical outlets where only one electrical socket is employed; engaging the unemployed socket of the double socket electrical outlets where only one electrical socket is employed with the one set of prongs of the portion cover; and saving the remaining portion cover for engaging another double socket electrical outlets where only one electrical socket is employed.

These and other features, aspects and advantages of the present invention will become better understood with reference to the following drawings, description and claims.

### BRIEF DESCRIPTION OF THE DRAWINGS

FIG. 1 is a perspective view of an electrical outlet covered by an electrical outlet cover according to an exemplary embodiment of the present invention;

FIG. 2 is an exploded perspective view of the electrical outlet and electrical outlet cover

FIG. 3 is a rear perspective view of the electrical outlet cover of FIG. 1;

FIG. 4 is a cross-sectional view taken along line 4-4 of FIG. 1;

FIG. 5 is a rear perspective view of an electrical outlet cover having a row of perforation for creating two separate portions of the electrical outlet cover;

FIG. 6 is a rear perspective view of a half-sized electrical outlet cover turned to cover an upper outlet of an electrical outlet;

FIG. 7 is a rear perspective view of the half-sized electrical outlet cover of FIG. 6, turned to cover a lower outlet of the electrical outlet; and

FIG. 8 is a rear perspective view of an electrical outlet cover having a row of perforation for creating two separate portions of the electrical outlet cover, each with a set of prongs.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an electrical outlet cover that is safe, accessible/removable, aesthetically pleasing, and adaptable and configurable in design. The electrical outlet cover can be used to cover outlets in older homes that may not be up to today's electrical codes, thus improving the safety of the home. The electrical outlet cover can also prevent children or pets from accessing any part of the wall outlet. The electrical outlet cover may form at least one row of perforation so as to be easily adapted to allow a user to manually tear, snap, break, or otherwise rend the configurable electrical outlet cover into at least two separate pieces without the need for a separate tool, such as a scissors or the like. As a result, the electrical outlet cover can cover an entire electrical outlet wall plate, or can be designed to cover an unused portion of the wall plate.

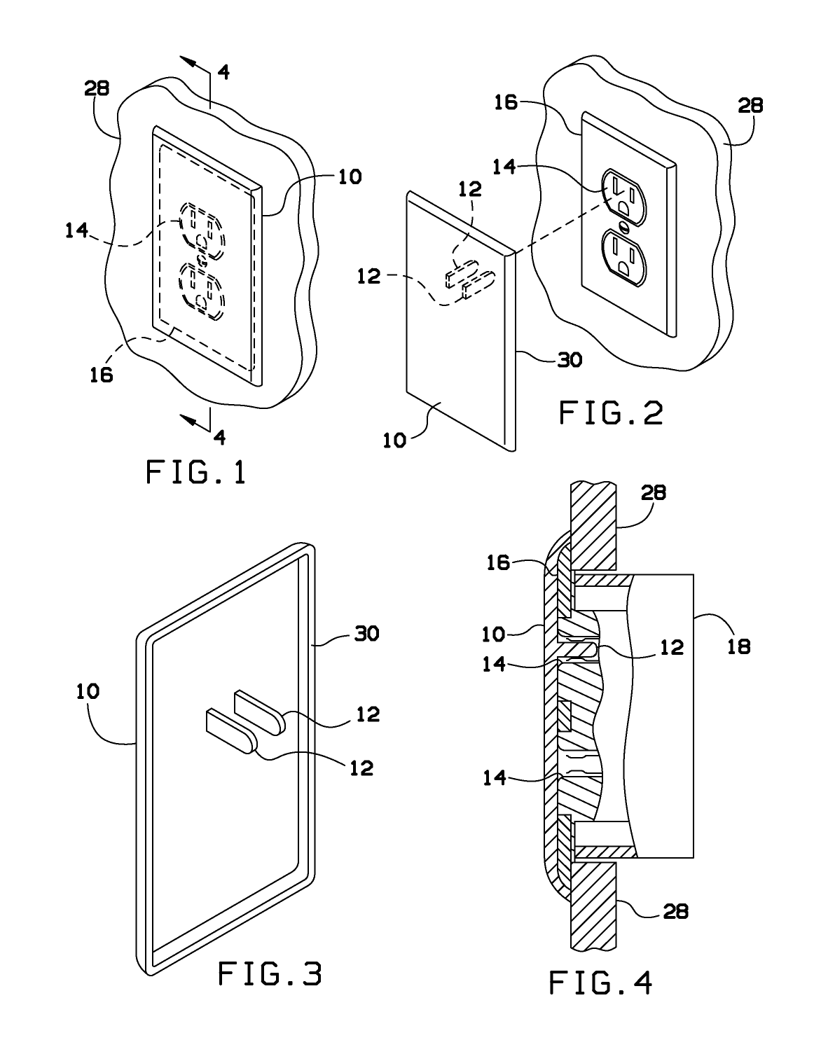

Referring now to FIGS. 1 through 4, an electrical outlet cover 10 can include a set of two prongs 12 disposed on a rear side of the electrical outlet cover 10 so as to be sized and spaced to engage electrical receptacles of a conventional socket and/or an electrical outlet 14 wall plate 16. The prongs 12 can be the same sized (non-polarized) so that the prongs 14 can fit into an upper one of the plugs in the outlet 14 (as shown in FIGS. 1, 2 and 4), or so that the electrical outlet cover 10 can be turned upside down and fit into a lower one of the plugs in the outlet 4. The prongs 12 are typically made of the same material as the electrical outlet cover 10 and are typically made integral therewith.

The prongs 12 allow the electrical outlet cover 10 to fit over the electrical outlet 14 without requiring the user to remove the electrical wall plate 16 from the electrical outlet box 18 inside the wall 28.

The electrical outlet cover 10 can be designed to fit completely over an electrical outlet wall plate 16. The electrical outlet cover 10 can include rounded edges 30 that can be disposed against a wall 28, as shown in FIG. 4. The front face and the sides of the electrical outlet cover 10 that are in view can be painted, wall papered, or otherwise designed as desired by the user, often in a manner similar to the surrounding wall.

Referring now to FIGS. 5 through 7, a configurable electrical outlet cover 20 can include at least one row of perforation 26 formed in the configurable electrical outlet cover 20 and adapted to allow a user to manually tear, snap, break, or otherwise rend the configurable electrical outlet cover 20 into at least two separate operable covers—a portion and a remaining portion—without the need for a separate tool, such as a scissors or the like. In certain embodiments, the at least one row of perforation 26 may extend generally horizontally from a first side 32 to a second side 34 so as not to bisect the prongs 12, as illustrated in FIG. 5. In certain embodiments, the at least one row of perforation 26 can define both a portion cover 22 and a remaining portion cover 24 of generally equal size. In some embodiments, the row of perforation 26 can be offset from center, where the portion covers 22 formed would cover slightly more than half of the electrical outlet 14 and where the remaining portion cover 24 would cover slightly less than half of the electrical outlet 14.

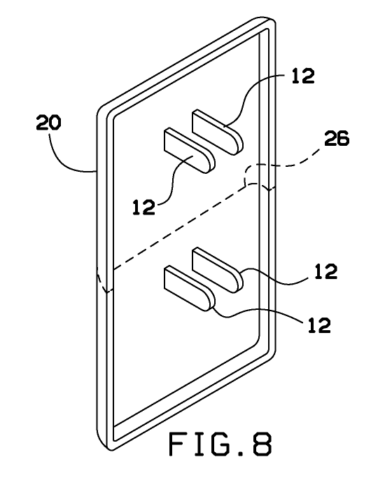

Referring to FIG. 8, the configurable electrical outlet cover 20 may include two sets of prongs 12 disposed on the rear side of the electrical outlet cover 20 so as to be appropriately sized and spaced to engage conventional electrical receptacles in a double socket electrical outlet 14 and its corresponding wall plate 16, wherein a row of perforation 26 extends between the two sets of prongs 12.

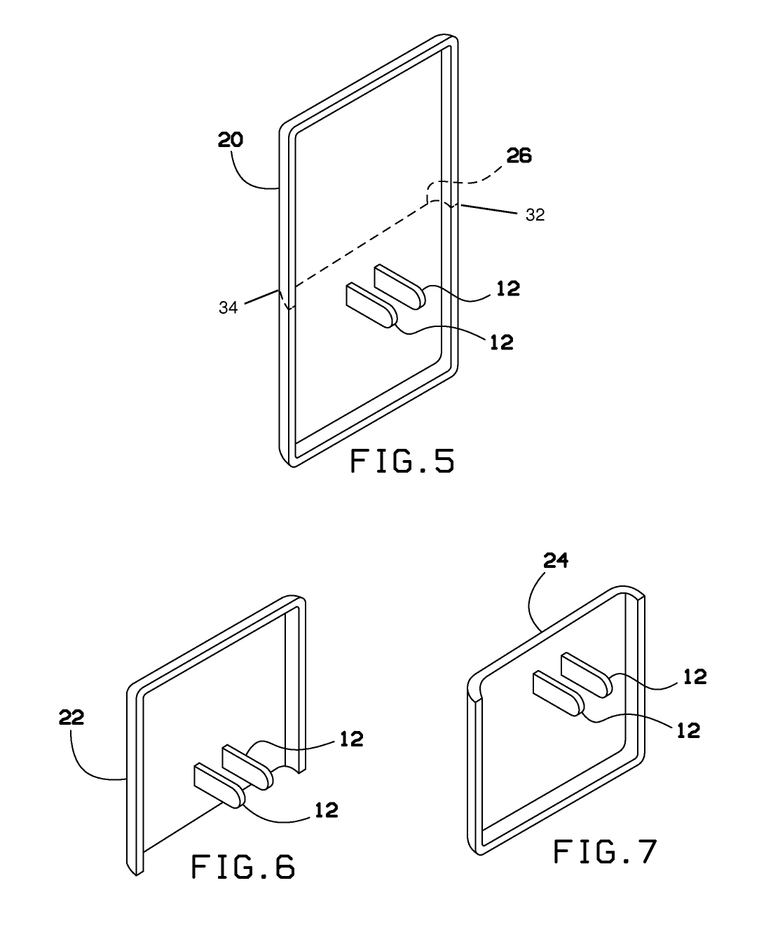

Accordingly, the configurable electrical outlet cover 20 of the present invention advantageously provides for an electrical outlet cover 20 that can be usefully employed multiple ways, where each configurable electrical outlet cover 20 can be used simultaneously for two separate electrical outlets wall plates 16. For example, a user interested in painting a large commercial space or child-proofing a large residential space may purchase a plurality of a single type configurable electrical outlet covers 20 so as to traverse the large space and, along the way, easily configure the most useful electrical outlet cover 20 on a case by case basis for each electrical outlet wall plate 16 encountered. By way of example, the user may be child-proofing a residential house where a dining room has three electrical outlets 14; a first plate 16 has two unused electrical outlet 14 sockets and a second plate 16 and a third plate 16 currently use one of two electrical outlets 14 sockets. The user may use just two of the single type of configurable electrical outlet covers 20 to child-proof the dining room: after using a first cover 20 to cover the first plate 16, the user can easily manually rend a second cover 20 along the at least one row of perforation 26 without out the aid of a tool so as to create the portion cover 22 and the remaining portion cover 24, as illustrated in FIGS. 6 and 7, to cover the second and the third wall plates 16. From there, the user may move from room to room configuring each electrical outlet cover 20 as they go from electrical outlet 14 to the next electrical outlet 14. Moreover, in certain embodiments, the user may also employ configurable electrical outlet covers 20 so as to adapt portion covers 22, 24 that are more or less than half of a particular wall plates 16, where, for example, a piece of furniture, wainscoting or the like makes generally equal portion covers 22, 24 inoperable. Also, because the configurable electrical outlet cover 20 may provide only two prong 12 per electrical outlet 14, the present invention is operable for older structures.

In some embodiments, the row of perforation may be configured to permit a user to remove only an outlet opening from either the top or bottom section of the outlet cover. This would allow access to half of the electrical outlet 14 while covering the entire outlet wall plate 16.

In some embodiments, the outlet cover can be configured as an elongated member having prongs from one side thereof. The elongated member can be designed to fit over or more outlets in an outlet strip. One or more row of perforations can be provided to adjust the size of the outlet cover.

The outlet cover of the present invention can be made from any number of non-conductive materials, such as plastic, nylon, rubber or the like. In some embodiments, the outlet cover is made of a rigid plastic or nylon material, for example. In other embodiments, the outlet cover is made of a more flexible plastic or rubber material, for example.

It should be understood, of course, that the foregoing relates to exemplary embodiments of the invention and that modifications may be made without departing from the spirit and scope of the invention as set forth in the 15 following claims.

What is claimed is:

1. A configurable electrical outlet covering device comprising:
a cover;
a set of prongs extending from a rear side of the cover, the set of prongs operable to fit into an electrical outlet;
rounded edges disposed about an outer periphery of the cover; and
a row of perforation formed in the cover and extending from a first side to a second side and adapted to allow a user to manually rend the cover into a portion cover and a remaining portion cover.

2. The configurable electrical outlet covering device of claim 1, further providing a second set of prongs extending from a rear side of the cover and disposed so as to operably engage double socket electrical outlet wall plates.

3. The configurable electrical outlet covering device of claim 1, wherein the row of perforation is disposed along a center of the cover to divide the cover into generally equal portion cover and remaining portion cover.

4. The configurable electrical outlet covering device of claim 2, wherein the row of perforation is disposed along a center of the cover to divide the cover into generally equal portion cover and remaining portion cover.

5. The configurable electrical outlet covering device of claim 1, wherein the row of perforation is disposed offset of center, wherein the portion cover having the set of prongs extending therefrom is longer than the remaining portion cover when the cover is separated along the row of perforation.

6. The configurable electrical outlet covering device of claim 2, wherein the row of perforation is disposed offset of center, wherein the portion cover having the set of prongs extending therefrom is longer than the remaining portion cover when the cover is separated along the row of perforation, wherein each portion and remaining cover has one set of prongs.

7. A method of child-proofing a plurality of double electrical outlet sockets using a single type of configurable electrical outlet cover in order to lower costs, comprising:
providing a plurality of configurable electrical outlet covers, wherein each configurable electrical outlet cover comprises:
a cover;
two sets of prongs extending from a rear side of the cover, wherein the two sets of prongs are disposed to operably engage double socket electrical outlets; and
a row of perforation formed in the cover and extending from a first side to a second side and adapted to allow a user to manually rend the cover into a portion cover and a remaining portion cover, each portion cover and remaining portion cover having one set of prongs;
engaging both sockets respectively with the two sets of prongs of one cover, when both electrical outlet sockets of the double socket electrical outlet are unemployed;
manually rending another configurable electrical outlet cover along the row of perforation, when confronted with a double socket electrical outlets where only one electrical socket is employed;
engaging the unemployed socket of the double socket electrical outlets where only one electrical socket is employed with the one set of prongs of the portion cover; and
saving the remaining portion cover for engaging another double socket electrical outlets where only one electrical socket is employed.

8. The method of claim 7, further providing rounded edges disposed about an outer periphery of the cover.
